(19) United States
(12) Patent Application Publication
(10) Pub. No.: US 2011/0190013 A1
(43) Pub. Date: Aug. 4, 2011

(54) Message Generating Method, Setting Method and Mobile Communication Device

(76) Inventor: Tung-Sheng Ting, Taipei Hsien (TW)

(21) Appl. No.: 12/955,922

(22) Filed: Nov. 30, 2010

(30) Foreign Application Priority Data
Feb. 2, 2010 (TW) 099102992

(51) Int. Cl. H04W 4/00

(52) U.S. Cl. 455/466

(57) ABSTRACT

A message generating method used in a mobile communication device is disclosed for reducing inconveniency when the mobile communication device is unable to be operated. The message generating method checks all messages received by the mobile communication device. If messages include an inquiry or setting command, the mobile communication device generates information of communication status or configures the device, and includes the information into one or more messages for a destination.

### BACKGROUND OF THE INVENTION

1. Field of the Invention

The present invention relates to a message generating method, setting method and mobile communication device, and more particularly, to a message generating method, setting method and mobile communication device capable of reducing inconvenience without altering technical specifications when the mobile communication device is unable to be operated.

2. Description of the Prior Art

With advancement and popularization of mobile communication technologies, wireless voices and data communication services are widely used by mass population, and affect life style, business model, etc. Therefore, when a user cannot operate a mobile phone, e.g. without bringing the mobile phone, inconvenience occurs and may affect the user's job.

Therefore, how to relieve the effect of forgetting a mobile phone has become an issue in industry.

### SUMMARY OF THE INVENTION

It is therefore an objective of the present invention to provide a message generating method, setting method and mobile communication device.

The present invention discloses a message generating method used in a mobile communication device for reducing inconvenience when the mobile communication device is unable to be operated. The message generating method includes receiving a message via a message transmission terminal, generating information of a communication status when the message comprises an inquiry command, and carrying the information of the communication status with at least one reply message, and transmitting the at least one reply message to a destination.

The present invention further discloses a mobile communication device capable of reducing inconvenience when the mobile communication device is unable to be operated. The mobile communication device includes an operating module, and a memory, storing a program, for instructing the operating module to perform following steps: receiving a message via a message transmission terminal, generating information of a communication status if the message comprises an inquiry command, and carrying the information of the communication status with at least one reply message, and transmitting the at least one reply message to a destination.

The present invention further discloses a setting method used in a mobile communication device for reducing inconvenience when the mobile communication device is unable to be operated. The setting method includes receiving a message via a message transmission terminal; and transferring a communication connecting request successively received by the mobile communication device to a destination when the message comprises a transfer command.

The present invention further discloses a mobile communication device capable of reducing inconvenience when the mobile communication device is unable to be operated. The mobile communication device includes an operating module, and a memory, storing a program, for instructing the operating module to perform following steps: receiving a message via a message transmission terminal, and transferring a communication connecting request successively received by the mobile communication device to a destination when the message comprises a transfer command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of operations of a mobile communication device according to an embodiment of the present invention.

FIG. 1B is a schematic diagram of a message generating process for the mobile communication device in FIG. 1A.

FIG. 2A is a schematic diagram of operations of another mobile communication device according to an embodiment of the present invention.

FIG. 2B is a schematic diagram of a setting process for the mobile communication device in FIG. 2A.

### DETAILED DESCRIPTION

In order to reduce inconvenience when a mobile communication device is unable to be operated, the present invention provides two methods of improvement. One is to transmit information of a communication status, such as information of missed calls of the mobile communication device or information of unread short messages received by the mobile communication device, etc., to a specific destination. The other is to transfer incoming calls or new short messages of the mobile communication device to another destination.

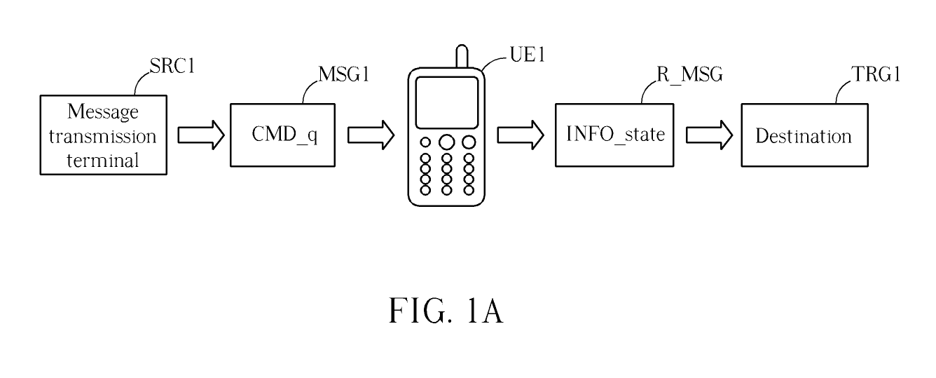

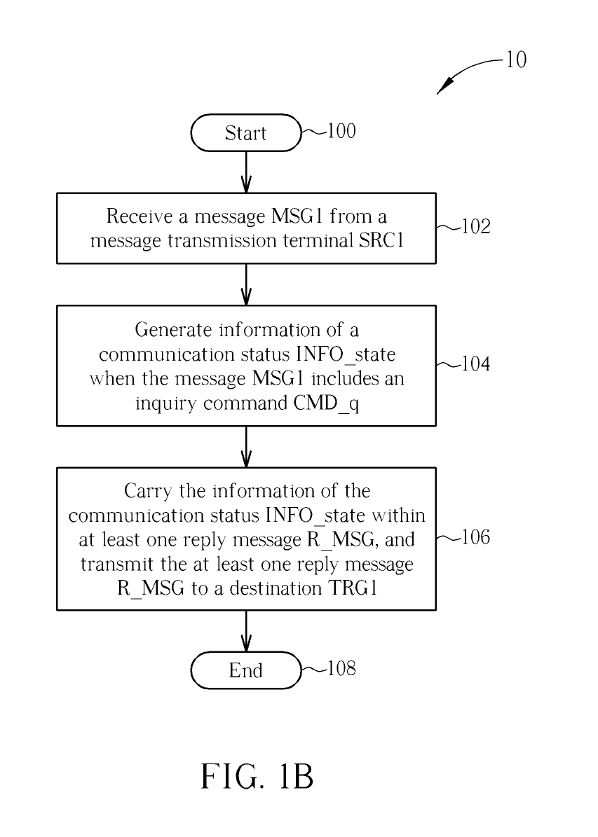

First, please refer to both FIG. 1A and FIG. 1B. FIG. 1A is a schematic diagram of operations of a mobile communication device UE1 according to an embodiment of the present invention, and FIG. 1B is a schematic diagram of a message generating process 10 of the mobile communication device UE1. The message generating process 10 can reduce the inconvenience when the mobile communication device UE1 is unable to be operated, and includes the following steps:

Step 100: Start.

Step 102: Receive a message MSG1 from a message transmission terminal SRC1.

Step 104: Generate information of a communication status INFO_state when the message MSG1 includes an inquiry command CMD_q.

Step 106: Carry the information of the communication status INFO_state within at least one reply message R_MSG, and transmit the at least one reply message R_MSG to a destination TRG1.

Step 108: End.

According to the message generating process 10, when the mobile communication device UE1 receives the message MSG1 from the message transmission terminal SRC1, if the message MSG1 includes the predefined inquiry command CMD_q, the mobile communication device UE1 carries the related information of the communication status INFO_state within the reply message R_MSG, and transmits the reply message R_MSG to the destination TRG1. In other words, when a user cannot operate the mobile communication device UE1 due to not bringing the mobile communication device UE1 or other reasons, the user can send the message MSG1 including the inquiry command CMD_q to the mobile communication device UE1 via the message transmission terminal SRC1. Thus, the mobile communication device UE1 transmits the information of the communication status INFO_state to the destination TRG1. By doing so, the user can acknowledge the information of missed calls, unread short messages, etc., so as to adopt proper measures.

Noticeably, in order to clearly illustrate the concept of the present invention, FIG. 1A is simplified to outline the spirit of the present invention, and those skilled in the art can make different alterations or modifications accordingly. For example, in FIG. 1A, the message transmission terminal SRC1 and the destination TRG1 are denoted by two blocks, but in practical, the message transmission terminal SRC1 and the destination TRG1 can be the same apparatus. The message transmission terminal SRC1 and the destination TRG1 are not limited to mobile phones, and can be computer systems as well. Certainly, the message MSG1 or the reply message R_MSG should be realized according to realizations of the message transmission terminal SRC1 and the destination TRG1. For example, if the message transmission terminal SRC1 and the destination TRG1 are the same mobile phone, the message MSG1 and the reply message R_MSG can be realized by short messages; if the message transmission terminal SRC1 is a mobile phone and the destination TRG1 is a computer system, the message MSG1 can be realized by a short message, and the reply message R_MSG can be realized by an electronic mail (email). By the same token, if the message transmission terminal SRC1 and the destination TRG1 are the same computer system, or the message transmission terminal SRC1 is a computer system and the destination TRG1 is a mobile phone, etc., the message MSG1 and the reply message R_MSG can be realized accordingly. However, in practical, whether the message transmission terminal SRC1 and the destination TRG1 are the same or detailed realizations of the message transmission terminal SRC1 and the destination TRG1 are not a subject matter of the present invention, and should not limit the scope of the present invention.

The main spirit of the message generating process 10 is to transmit the information of the communication status INFO_state, such as missed calls, unread short messages, etc., to the destination TRG1 when the mobile communication device UE1 receives the specific inquiry command CMD_q. By doing so, the user can acknowledge whether important incoming calls or short messages are missed via the destination TRG1, so as to adopt proper measures. All alterations or modifications according to the concept should belong to the scope of the present invention. For example, the inquiry command CMD_q can include a specific string or a verification code, etc., for verifying validity of the inquiry command CMD_q, so as to prevent improperly transmitting the information of the communication status INFO_state. In addition, other than the message transmission terminal SRC1, the destination TRG1 can be a mobile phone, an email, etc., predefined by the mobile communication device UE1 or assigned by the inquiry command CMD_q.

Moreover, operations of the mobile communication device UE1 to transmit the reply message R_MSG can also be altered. For example, the method can be a one-time transmission, i.e. the mobile communication device UE1 only transmits the reply message R_MSG one time whenever the inquiry command CMD_q is received. The replied information of the communication status can be presented with various forms. For example, the replied information can include statistic information of the communication status, such as the number of missed calls, the number of unread short messages received by the mobile communication device UE1. The replied information can include communication information, such as phone numbers of missed calls, phone numbers of transmission terminals of the unread short messages received by the mobile communication device UE1. Besides, the replied information can include contents of the unread short messages received by the mobile communication device UE1, etc.

Whatever alterations or modifications are made, the main spirit of the message generating process 10 is to “passively” transmit the information of the communication status INFO_state to the destination TRG1. The quote “passively” means that the mobile communication device UE1 transmits the information of the communication status INFO_state to the destination TRG1 only when the correct inquiry command CMD_q is received. Whether the message transmission terminal SRC1 and the destination TRG1 are the same, formats of the message MSG1 and the reply message R_MSG, contents of the inquiry command CMD_q and the information of the communication status INFO_state, etc., should not limit the concept of the present invention.

On the other hand, the message generating process 10 can be realized by software or firmware. That is, the message generating process 10 can be compiled into a program, which is stored in a memory or a storage device, such that an operating module (such as a CPU) of the mobile communication device UE1 can realize the steps of the message generating process 10 accordingly. Such transformation should be well-known by those skilled in the art, and is not narrated hereinafter.

Other than transmitting the information of the communication status INFO_state, the present invention can also reduce the inconvenience by transferring incoming calls or short messages when the mobile communication device is unable to be operated.

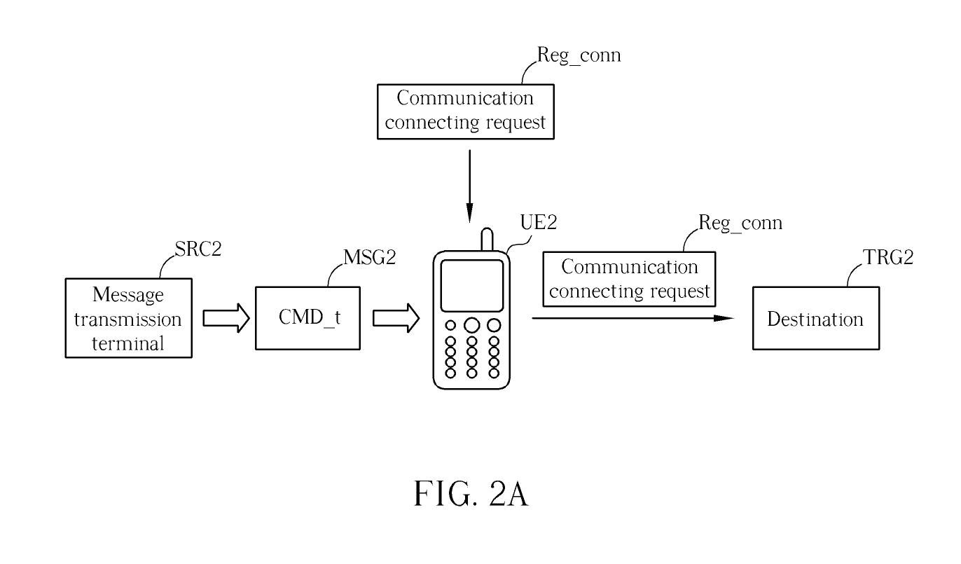

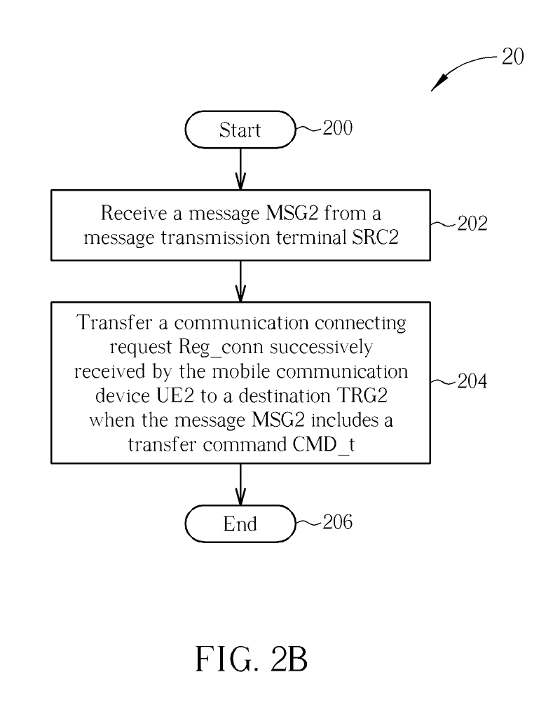

Please refer to FIG. 2A and FIG. 2B. FIG. 2A is a schematic diagram of operations of a mobile communication device UE2 according to an embodiment of the present invention, and FIG. 2B is a schematic diagram of a setting process 20 of the mobile communication device UE2. The setting process 20 can reduce the inconvenience when the mobile communication device UE2 is unable to be operated, and includes the following steps:

Step 200: Start.

Step 202: Receive a message MSG2 from a message transmission terminal SRC2.

Step 204: Transfer a communication connecting request Reg_conn successively received by the mobile communication device UE2 to a destination TRG2 when the message MSG2 includes a transfer command CMD_t.

Step 206: End.

According to the setting process 20, when the mobile communication device UE2 receives the message MSG2 from the message transmission terminal SRC2, if the message MSG2 includes the predefined transfer command CMD_t, the mobile communication device UE2 activates a function of transferring incoming calls, such that the communication connecting request Reg_conn is directly transferred to the predefined destination TRG2 via a telecommunications system. If the message MSG2 includes the predefined message transfer command CMD_t, the mobile communication device UE2 transfers a newly received message to the destination TRG2, in order to instantly transmit the message. In other words, when the user cannot operate the mobile communication device UE2 due to not bringing the mobile communication device UE2 or other reasons, the user can send the message MSG2 including the transfer command CMD_t to the mobile communication device UE2 via the message transmission terminal SRC2, such that the mobile communication device UE2 transfers the successively received communication connecting request Reg_conn to the destination TRG2. As a result, the user can receive incoming calls of the mobile communication device UE2 or short messages transmitted to the mobile communication device UE2, etc., via the destination TRG2, to avoid missing calls or short messages, etc.

Noticeably, in order to clearly illustrate the concept of the present invention, FIG. 2A is also simplified to outline the spirit of the present invention, and those skilled in the art can make different alterations or modifications accordingly. For example, in FIG. 2A, the message transmission terminal SRC2 and the destination TRG2 can be the same or different apparatuses, which are not limited to mobile phones, and can be computer systems as well.

Unlike the message generating process 10, possible modifications of the setting process 20 are more related to a transfer method of the communication connecting request Reg_conn (or realization of the destination TRG2). For example, assume that the mobile communication device UE2 is configured to transfer the communication connecting request Reg_conn of instant voices (such as incoming calls) to the destination TRG2. At the meantime, if the destination TRG2 is a mobile phone, the transfer method of the communication connecting request Reg_conn can be realized by an ordinary call transferring technique. Besides, assume that the mobile communication device UE2 is configured to transfer the communication connecting request Reg_conn of short messages to the destination TRG2. At the meantime, if the destination TRG2 is a mobile phone, the transfer method of the communication connecting request Reg_conn can be realized by an ordinary short message transferring technique. If the destination TRG2 is a computer system, the transfer method of the communication connecting request Reg_conn needs to transform short messages into emails, in order to realize short message transferring. However, in practical, how to transfer the communication connecting request Reg_conn, whether the message transmission terminal SRC2 and the destination TRG2 are the same and detailed realizations of the message transmission terminal SRC2 and the destination TRG2, etc., are not a subject matter of the present invention, and should not limit the scope of the present invention.

The main spirit of the setting process 20 is to transfer successive incoming calls, short messages, etc. to the destination TRG2 when the mobile communication device UE2 receives the specific transfer command CMD_t. By doing so, the user can receive incoming calls of the mobile communication device UE2 or short messages transmitted to the mobile communication device UE2 via the destination TRG2, to avoid missing important incoming calls or short messages. All alterations or modifications according to the concept should belong to the scope of the present invention. For example, the transfer command CMD_t can include a specific string or a verification code, etc., for verifying validity of the transfer command CMD_t to avoid improperly transferring the communication connecting request Reg_conn. In addition, other than the message transmission terminal SRC2, the destination TRG2 can also be a mobile phone, an address of a computer system, etc., predefined by the mobile communication device UE2 or assigned by the transfer command CMD_t.

Moreover, operations of the mobile communication device UE2 to transfer the communication connecting request Reg_conn can also be altered. For example, the mobile communication device UE2 can transfer a new message to the destination TRG2 immediately after the new message is received, or the mobile communication device UE2 can transfer new messages periodically, i.e. the mobile communication device UE2 transfers received new messages periodically after the transfer command CMD_t is received. Under such a situation, the period or the number of new messages can be further limited, or another command can be utilized for terminating the continuous transferring.

Similar to the message generating process 10, the main spirit of the setting process 20 is also to “passively” transfer the communication connecting request Reg_conn to the destination TRG2. The quote “passively” means that the mobile communication device UE2 activates transferring the communication connecting request Reg_conn to the destination TRG2 only when the correct transfer command CMD_t is received. Whether the message transmission terminal SRC2 and the destination TRG2 are the same, formats of the message MSG2, contents of the transfer command CMD_t, whether the communication connecting request Reg_conn is transformed, etc., should not limit the concept of the present invention.

On the other hand, the setting process 20 can be realized by software or firmware. That is, the setting process 20 is compiled into a program, which is stored in a memory or a storage device, such that an operating module (such as a CPU) of the mobile communication device UE2 can realize the steps of the setting process 20 accordingly. Such transformation should be well-known by those skilled in the art, and is not narrated hereinafter.

In the prior art, the user cannot operate the mobile phone when forgetting the mobile phone, resulting in inconvenience and influence on jobs. In comparison, the present invention provides two improvement methods. One is, as shown in FIG. 1A and FIG. 1B, to transmit the information of the communication status of the mobile communication device, such as the information of missed calls or the information of unread short messages received by the mobile communication device, etc., to a specific destination. The other is, as shown in FIG. 2A and FIG. 2B, to transfer incoming calls or new short messages of the mobile communication device to another destination. As a result, the user can acknowledge the information of the communication status of the mobile communication device or receive transferred incoming calls and short messages via other communication devices, so as to avoid trouble of missing incoming calls or short messages.

To sum up, the present invention can effectively reduce the inconvenience when the mobile communication device is unable to be operated, so as to avoid affecting life or jobs of the user.

Those skilled in the art will readily observe that numerous modifications and alterations of the device and method may be made while retaining the teachings of the invention.

What is claimed is:

1. A message generating method used in a mobile communication device, comprising:
receiving a message via a message transmission terminal;
generating information of a communication status when the message comprises an inquiry command; and
carrying the information of the communication status within at least one reply message, and transmitting the at least one reply message to a destination.

2. The message generating method of claim 1, wherein the information of the communication status comprises information of missed calls of the mobile communication device or information of unread short messages received by the mobile communication device.

3. The message generating method of claim 1, wherein the message transmission terminal is another mobile communication device, and the message and the at least one reply messages are short messages.

4. The message generating method of claim 1, wherein the message transmission terminal is a computer system, and the message and the at least one reply messages are electronic mails (emails).

5. The message generating method of claim 1, wherein the message transmission terminal and the destination are the same.

6. The message generating method of claim 1, wherein the message transmission terminal and the destination are different, and the destination is predefined by the mobile communication device or the destination is assigned by the inquiry command, wherein the inquiry command comprises a verification code, for verifying validity of the inquiry command.

7. A mobile communication device capable, comprising:
an operating module; and
a memory, storing a program, for instructing the operating module to perform following steps:
receiving a message via a message transmission terminal;
generating information of a communication status if the message comprises an inquiry command; and
carrying the information of the communication status within at least one reply message, and transmitting the at least one reply message to a destination.

8. The mobile communication device of claim 7, wherein the information of the communication status comprises information of missed calls of the mobile communication device or information of unread short messages received by the mobile communication device.

9. The mobile communication device of claim 7, wherein the message transmission terminal is another mobile communication device, and the message and the at least one reply messages are short messages.

10. The mobile communication device of claim 7, wherein the message transmission terminal is a computer system, and the message and the at least one reply messages are electronic mails (emails).

11. The mobile communication device of claim 7, wherein the message transmission terminal and the destination are the same.

12. The mobile communication device of claim 7, wherein the message transmission terminal and the destination are different, and the destination is predefined by the mobile communication device Or the destination is assigned by the inquiry command, wherein the inquiry command comprises a verification code, for verifying validity of the inquiry command.

13. A setting method used in a mobile communication device, comprising:
receiving a message via a message transmission terminal; and
transferring a communication connecting request successively received by the mobile communication device to a destination when the message comprises a transfer command.

14. The setting method of claim 13, wherein the communication connecting request is a voice communication connecting request and the destination is a communication device.

15. The setting method of claim 13, wherein the communication connecting request is a short message reception request and the destination is another mobile communication device or a computer system.

16. The setting method of claim 13, wherein the message transmission terminal is another mobile communication device, and the message is a short message.

17. The setting method of claim 13, wherein the message transmission terminal is a computer system, and the message is an electronic mail (email).

18. The setting method of claim 13, wherein the message transmission terminal and the destination are the same.

19. The setting method of claim 13, wherein the message transmission terminal and the destination are different, and the destination is predefined by the mobile communication device Or the destination is assigned by the inquiry command, wherein the inquiry command comprises a verification code, for verifying validity of the inquiry command.

20. The setting method of claim 13 further comprising stopping transferring the communication connecting request received by the mobile communication device to the destination when a termination command is received.

21. A mobile communication device capable, comprising:
an operating module; and
a memory, storing a program, for instructing the operating module to perform following steps:
receiving a message via a message transmission terminal; and
transferring a communication connecting request successively received by the mobile communication device to a destination when the message comprises a transfer command.

22. The mobile communication device of claim 21, the communication connecting request is a voice communication connecting request and the destination is a communication device.

23. The mobile communication device of claim 21, wherein the communication connecting request is a short message reception request and the destination is another mobile communication device or a computer system.

24. The mobile communication device of claim 21, wherein the message transmission terminal is another mobile communication device, and the message is a short message.

25. The mobile communication device of claim 21, wherein the message transmission terminal is a computer system, and the message is an electronic mail (email).

26. The mobile communication device of claim 21, wherein the message transmission terminal and the destination are the same.

27. The mobile communication device of claim 21, wherein the message transmission terminal and the destination are different, and the destination is predefined by the mobile communication device or the destination are different, and the destination is assigned by the transfer command or the transfer command comprises a verification code, for verifying validity of the transfer command, the transfer command comprises a verification code, for verifying validity of the transfer command.

28. The mobile communication device of claim 21 further comprising stopping transferring the communication connecting request received by the mobile communication device to the destination when a termination command is received.
